(19) United States
(12) Patent Application Publication
(10) Pub. No.: US 2026/0284450 A1
(43) Pub. Date: Sep. 24, 2026

(54) FALL PROTECTION CABLE SYSTEM CONFIGURED TO CREATE A CONTROLLED ACCESS ZONE ON THE ROOF OF A STEEL BUILDING AND METHOD OF USE AND INSTALLATION THEREOF

(71) Applicant: Jonathan W. Wilson, Denver, NC (US)

(72) Inventor: Jonathan W. Wilson, Denver, NC (US)

(21) Appl. No.: 19/087,885

(22) Filed: Mar. 24, 2025

(51) Int. Cl. A62B 35/00

(52) U.S. Cl. CPC A62B 35/0056; A62B 35/0068

(57) ABSTRACT

A fall protection cable system configured for creating a controlled access zone on the roof of a steel building includes a plurality of support members. Each support member is configured to attach to a top of the roof on the steel building. A fall protection cable is interconnected between each of the plurality of support members at an elevated position above the top of the roof on the steel building. Wherein, the fall protection cable is configured for allowing a worker to tie off to the fall protection cable at the elevated position above the roof while working on the roof. The controlled access zone is created by interconnecting the fall protection cable or a boundary line between each of the plurality of support members positioned on the roof of the steel building.

### FIELD OF THE DISCLOSURE

The present disclosure is directed toward steel buildings and the construction thereof. More specifically, the present disclosure relates to a fall protection cable system configured to create a controlled access zone (“CAZ”) on the roof of a steel building and a method of use and installation thereof.

### BACKGROUND

Generally speaking, a steel building is a metal structure fabricated with steel for the internal support and for exterior cladding, as opposed to steel framed buildings which generally use other materials for floors, walls, and external envelope. Steel buildings are used for a variety of purposes including storage, work spaces and living accommodation. They are classified into specific types depending on how they are used.

Steel provides several advantages over other building materials, such as wood. Steel is structurally sound and manufactured to strict specifications and tolerances. Any excess material is 100% recyclable. Steel does not easily warp, buckle, twist or bend, and is therefore easy to modify and offers design flexibility. Steel is also easy to install, is cost effective, and rarely fluctuates in price. Steel also allows for improved quality of construction and less maintenance, while offering improved safety and resistance. Furthermore, with the propagation of mold and mildew in residential buildings, using steel versus wood minimizes these infestations, as mold needs moist, porous material to grow and steel studs do not have those problems.

Some common types of steel buildings are “straight-walled” and “arch,” or Nissen or Quonset hut. Further, the structural type may be classed as clear span or multiple spans. A clear span building does not have structural supports (e.g. columns) in the interior occupied space. Straight-walled, and arch type, refer to the outside shape of the building. More generally, these are both structural arch forms if they rely on a rigid frame structure. However, curved roof structures are typically associated with the arch term. Steel arch buildings may be cost efficient for specific applications. They are commonly used in the agricultural industry. Straight-walled buildings provide more usable space when compared to arch buildings. They are also easier to blend into existing architecture. Straight-walled buildings are commonly used for commercial, industrial, and many other occupancy types. Clear span refers to the internal construction. Clear span steel buildings utilize large overhead support beams, thus reducing the need for internal supporting columns. Clear span steel buildings tend to be less cost efficient than structures with interior columns. However, other practical considerations may influence the selection of framing style, such as occupancy, where interior structural obstructions are undesirable (e.g. aircraft hangars or sport arenas). Long Bay buildings are designed for use in bay spans of over 35′. They use prefabricated metal frames combined with conventional joists to provide larger openings and clearances in buildings.

There are five main types of structural components that make up a steel frame: tension members, compression members, bending members, combined force members and their connections. Tension members are usually found as web and chord members in trusses and open web steel joists. Ideally tension members carry tensile forces, or pulling forces, only and its end connections are assumed to be pinned. Pin connections prevent any moment (rotation) or shear forces from being applied to the member. Compression members are also considered as columns, struts, or posts. They are vertical members or web and chord members in trusses and joists that are in compression or being squished. Bending members are also known as beams, girders, joists, spandrels, purlins, lintels, and girts. Each of these members have their own structural application, but typically bending members will carry bending moments and shear forces as primary loads and axial forces and torsion as secondary loads. Combined force members are commonly known as beam-columns and are subjected to bending and axial compression. Connections are what bring the entire building together. They join these members together and must ensure that they function together as one unit.

One problem that has been discovered with the construction of steel buildings is the dangers associated with roofing or installation of the roofing panels on the steel building structure, and the subsequent work needed on top of the installed roofing panels on the steel building structure. During this process, workers are positioned at elevated heights above the ground to install and work on the roofing panels where they may be required to balance or hang over or on an edge, a beam, the like, etc. Although the workers may be required to be tied off during this working or construction process, this is not practical during a lot of times of the working process, as this tying off process is difficult in certain locations and extremely time consuming. This difficulty in tying off leads to a significant risk of falling as the workers complete the installation of roofing panels and work thereon, which can lead to serious injury or even death. As such, there is clearly a need to provide a means or system that is easier and less time consuming to allow workers to be tied off during the entire roofing process and work thereon.

One known fall protection cable system for roofing installation on steel buildings is disclosed in U.S. Pat. No. 11,484,735, incorporated herein in its entirety. In the system disclosed in U.S. Pat. No. 11,484,735, a starting support post and a final support post are included that are attached on sides of the steel building. These starting ang final support posts are anchored to the ground on each side of the building. As such, the system disclosed in U.S. Pat. No. 11,484,735 requires a plurality of ground anchors to be installed around the building. These ground anchors are time consuming to install and add a layer of complexity and cost to the roofing installation process. As such, there is clearly a need to provide a fall protection cable system for working on the roof of steel building that does not require ground anchors.

In addition, the instant disclosure recognizes that during and after the installation of a metal roof, there is a need to create a controlled access zone, also known as a “CAZ”. The Occupational Safety and Health Administration (“OSHA”) defines a controlled access zone as an area in which certain work may take place without the use of guardrail systems, personal fall arrest systems, or safety net systems, and access to the zone is controlled. OSHA safety requirements for controlled access zones include: defining the area clearly and ensure that appropriate signage is posted to prevent unauthorized personnel from entering; ensure that only authorized workers are entering the area; each employee working in a controlled access zone must be directed by a competent safety monitor; employees working in a controlled access zone must respond quickly to any warnings or promptings by the safety monitor; control lines must be erected at a minimum distance of 6 feet and a maximum distance of 25 feet from the leading edge control lines must be marked out clearly and made highly visible at intervals of 6 feet or less; the lowest point (including sagging) must be at least 39 inches above the working area and no higher than 45 inches; control lines are required to withstand at least 200 pounds of weight; and the safety monitor must be a competent individual who does not have conflicting responsibilities on the job site, a monitor must have a clear line of vision to the workers at all times, and be prepared to quickly identify hazards and warn a worker when a hazard presents itself, or if the worker is acting unsafely. Providing a CAZ on top of a roof where workers are not required to be tied off is clearly desired to provide for an efficient and safe workplace. However, there are no known fall protection cable systems that provide a means or configuration for providing or creating a CAZ on top of the roof of steel buildings.

The present disclosure may be designed to address at least certain aspects of the problems discussed above by providing a fall protection cable system configured to create a controlled access zone on the roof of a steel building and method of use and installation thereof.

### SUMMARY

In accordance with at least selected embodiments, the instant disclosure may address at least certain aspects of the above mentioned needs, issues and/or problems and may provide a fall protection cable system configured to create a controlled access zone on the roof of a steel building. The disclosed fall protection cable system configured to create a controlled access zone may be configured for working on a roof on a steel building. The fall protection cable system configured to create a controlled access zone may generally include a plurality of support members. Each support member may be configured to attach to a top of the roof on the steel building. A fall protection cable may be interconnected between each of the plurality of support members at an elevated position above the top of the roof on the steel building. Wherein the fall protection cable may be configured for allowing a worker to tie off to the fall protection cable at the elevated position above the top of the roof while working on the top of the roof.

In select embodiments of the disclosed fall protection cable system, the plurality of support members may include at least one standard support member. Each of the at least one standard support member may include a vertical main support post and a bracing strut. The vertical main support post may be configured to be attached to the top of the roof of the steel building at a main support location. The vertical main support post may include a bracing connection affixed at a connection point on the vertical main support post. The bracing strut may be configured to be attached to the top of the roof of the steel building at a bracing support location. The bracing strut may be configured to be interconnected between the top of the roof at the bracing support location and the bracing connection affixed to the vertical main support post at the connection point. Wherein, the vertical main support post may be reinforced in a reinforcing direction by the bracing strut.

In other select embodiments of the fall protection cable system, the plurality of support members may include at least one corner support member. Each of the at least one corner support member may include the vertical main support post and two bracing struts. As with the standard support member, the vertical main support post may be configured to be attached to the top of the roof of the steel building at the main support location. But the vertical main support post of the corner support member may include two bracing connections affixed at the connection point on the vertical main support post. The two bracing struts may be configured to be attached to the top of the roof of the steel building at two bracing support locations. One of the two bracing struts may be configured to be interconnected between the top of the roof at one of the two bracing support locations and one of the two bracing connections affixed to the vertical main support post at the connection point. The other of the two bracing struts may be configured to be interconnected between the top of the roof at the other of the two bracing support locations and the other of the two bracing connections affixed to the vertical main support post at the connection point. Wherein, the vertical main support post of the corner support members may be reinforced in two reinforcing directions by the two bracing struts.

In select embodiments of the disclosed fall protection cable system, the vertical main support post may include a main base. The main base may be configured to attach the vertical main support post to the top of the roof of the steel building at the main support location.

In select embodiments of the disclosed fall protection cable system, the bracing strut may include a bracing base. The bracing base may be configured to attach the bracing strut to the top of the roof of the steel building at the bracing support location.

In select embodiments of the disclosed fall protection cable system, the main base and/or the bracing base may include a first connecting side, a second connecting side, and at least one telescoping member. The at least one telescoping member may be interconnected between the first connecting side and the second connecting side. Wherein, a base width between the first connecting side and the second connecting side may be configured to be adjustable to fit the first connecting side on a first seam of the roof and the second connecting side on an adjacent second seam of the roof. In select embodiments, the first connecting side may include a first clamp configured to affix the first connecting side on the first seam of the roof, and the second connecting side may include a second clamp configured to affix the second connecting side on the second seam of the roof. In select embodiments, the first clamp and the second clamp of each of the main base and the bracing base may include a C-channel bracket and a flat bracket. The flat bracket may be adjustably attached to ends of the C-channel bracket via at least one clamp screw. Wherein, when a bottom member of the C-channel bracket is positioned below a lip of a seam of the roof on a first seam side of the seam and the flat bracket is positioned on a second seam side of the seam, and each of the at least one clamp screw is tightened, the flat bracket and the bottom member of the C-channel bracket may be compressed together to lock onto the seam with the bottom member of the C-channel bracket locked in position below the lip of the seam of the roof on the first seam side of the seam. In select possibly preferred embodiments, the flat bracket may be adjustably attached to the ends of the C-channel bracket via three clamp screws.

In select embodiments of the disclosed fall protection cable system, the main base and/or the bracing base may include three telescoping members interconnected between the first connecting side and the second connecting side. In select embodiments, the main base and/or the bracing base may include two outer circular telescoping members and an inner rectangular telescoping member. The two outer circular telescoping members may be interconnected between the first connecting side and the second connecting side. The inner rectangular telescoping member may be interconnected between the first connecting side and the second connecting side. The inner rectangular telescoping member may be positioned between the two outer circular telescoping members. In select embodiments, the main base may include the vertical main support post being affixed to the inner rectangular telescoping member. In these embodiments, the vertical main support post may be supported in a perpendicular orientation to the inner rectangular telescoping member via a plurality of support wedges. In select embodiments, the bracing base may include a bracing flange. The bracing flange may be affixed to the inner rectangular telescoping member. The bracing strut may be removably affixed to the bracing flange on the inner rectangular telescoping member via a plurality of bracing bolts.

One feature of the disclosed fall protection cable system may be that the vertical main support post of each of the plurality of support members may include a passage at a distal end. The passage at the distal end of the vertical main support post of each of the plurality of support members may be configured to receive the fall protection cable or a boundary line therethrough for supporting the fall protection cable or the boundary line above the roof. In select embodiments, and clearly not limited thereto, the passage may be created on the distal end of the vertical main support post via two hook members. The two hook members may be affixed to the distal end of the vertical main support post on opposing sides of the distal end of the vertical main support post. One of the two hook members may have a first opening facing a first direction, and the other of the two hook members may have a second opening facing a second direction that is opposite of the first direction of the first opening. In other select embodiments, the passage may be created on the distal end of the vertical main support post via an eyebolt.

Another feature of the disclosed fall protection cable system may be that the fall protection cable system can be configured to create a controlled access zone. The controlled access zone or CAZ may be created via the fall protection cable or the boundary line being interconnected between each of the plurality of support members positioned on the roof of the steel building. In select embodiments, the plurality of support members may be positioned around a perimeter of the roof. The plurality of support members may be positioned around the perimeter of the roof at a set separation distance apart and/or at a set offset distance from an edge of the roof. Whereby, the controlled access zone may be an enclosed area on the top of the roof defined by the fall protection cable or the boundary line interconnected between each of the plurality of support members positioned around the perimeter of the roof.

Another feature of the disclosed fall protection cable system may be that the fall protection cable and/or the boundary line interconnected between each of the plurality of support members may include flags or streamers attached thereto. The flags or streamers may be attached on the fall protection cable and/or boundary line a set visibility distance a part. The flags or streamers on the fall protection cable and/or the boundary line may be configured to provide visibility to the fall protection cable or the boundary line for defining the controlled access zone.

In select embodiments of the disclosed fall protection cable system, the vertical main support post of each of the plurality of support members may include a cable mounting flange. The cable mounting flange may be affixed at a shortened elevated position on the vertical main support post. The cable mounting flange may include a hole therethrough configured to receive the fall protection cable. In these embodiments with the shortened elevated position for the fall protection cable, the fall protection cable system may be configured to create a controlled access zone via the boundary line being interconnected between each of the plurality of support members at the passage on the distal end of the vertical main support post of each of the plurality of support members. In addition, the fall protection cable system may be configured to allow the worker to tie off to the fall protection cable at the shortened elevated position via the fall protection cable being interconnected between each of the plurality of support members through the hole in the cable mounting flange affixed on the vertical main support post of each of the plurality of support members.

In another aspect, the instant disclosure embraces the disclosed fall protection cable system in any of the embodiments and/or combinations of embodiments shown and/or described herein.

In another aspect, the instant disclosure embraces the disclosed fall protection cable system configured for creating the controlled access zone on a roof of a steel building in any of the embodiments and/or combinations of embodiments shown and/or described herein. In select embodiments, the fall protection cable system configured for creating the controlled access zone on a roof of a steel building may include the plurality of support members. Each support member may be configured to attach to a top of the roof on the steel building. The fall protection cable may be interconnected between each of the plurality of support members at an elevated position above the top of the roof on the steel building. Wherein, the fall protection cable may be configured for allowing a worker to tie off to the fall protection cable at the elevated position above the top of the roof while working on the top of the roof. In addition, the fall protection cable system may be configured to create a controlled access zone via the fall protection cable or a boundary line being interconnected between each of the plurality of support members positioned on the roof of the steel building.

In another aspect, the instant disclosure embraces a method of working on a roof of a steel building. The method of working on a roof of a steel building may generally include utilizing the disclosed fall protection cable system configured for creating the controlled access zone on a roof of a steel building in any of the embodiments and/or combinations of embodiments shown and/or described herein. As such, the disclosed method of working on a roof of a steel building may include installing the fall protection cable system on the roof of the steel building. The fall protection cable system installed may generally include: a plurality of support members, each support member is configured to attach to a top of the roof on the steel building; a fall protection cable interconnected between each of the plurality of support members at an elevated position above the top of the roof on the steel building; wherein the fall protection cable is configured for allowing a worker to tie off to the fall protection cable at the elevated position above the roof while working on the roof. With the fall protection cable system installed, the disclosed method of working on a roof of a steel building may further include creating a controlled access zone by interconnecting the fall protection cable or a boundary line between each of the plurality of support members positioned on the roof of the steel building.

In select embodiments of the disclosed method of working on the roof of a steel building, wherein each of the plurality of support members of the fall protection cable system further include: a vertical main support post configured to be attached to the top of the roof of the steel building at a main support location, the vertical main support post including a bracing connection affixed at a connection point on the vertical main support post; a bracing strut configured to be attached to the top of the roof of the steel building at a bracing support location; wherein, the bracing strut is configured to be interconnected between the top of the roof at the bracing support location and the bracing connection affixed to the vertical main support post at the connection point; and whereby, the vertical main support post is reinforced in a reinforcing direction by the bracing strut. In these embodiments, the installing of the fall protection cable system on the roof of the building may include installing each of the plurality of support members. The installation of each of the plurality of support members may include: attaching the vertical main support post to the top at the main support location of the roof via a main base; and reinforcing the vertical main support post via the bracing strut by attaching the bracing strut to the top at the bracing support location via a bracing base, and interconnecting the bracing strut between the bracing base and the bracing connection on the vertical main support post.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is an environmental perspective view of the fall protection cable system configured to create a controlled access zone on the roof of a steel building according to select embodiments of the instant disclosure installed on the top of the roof of a steel building;

FIG. 2 is a perspective side view of a support member with a vertical main support post reinforced by a bracing strut according to select embodiments of the instant disclosure for the fall protection cable system configured to create a controlled access zone on the roof of a steel building;

FIG. 3 is a disassembled perspective view of the support member with the vertical main support post reinforce by the bracing strut from FIG. 2;

FIG. 4A is an environmental perspective view of a worker installing the support member from FIG. 2 on the roof of a steel building, showing the worker loosening the bolts on the main base with the vertical main support for installation on the roofing panel;

FIG. 4B is a zoomed in view of the main base and the bracing base of the support member from FIG. 2 installed on the seams of a roof.

FIG. 5A is another environmental perspective view of a worker installing the support member from FIG. 2 on the roof of a steel building showing the worker tightening the bolts on the main base for installation on the roofing panel;

FIG. 5B is a zoomed in view of one side of the bracing base from the support member of FIG. 2 installed in position with the clamp tightened on the seam of the roof with the bottom member of the C-channel bracket positioned below the lip of the seam;

FIG. 5C is a zoomed in view of FIG. 5B showing the one side of the bracing base from the support member of FIG. 2 installed in position with the clamp tightened on the seam of the roof with the bottom member of the C-channel bracket positioned below the lip of the seam;

FIG. 6 is an environmental perspective view of a worker installing the support member from FIG. 2 on the roof of a steel building, showing the worker loosening the clamp bolts on the bracing base for the bracing strut for installation on the roofing panel;

FIG. 7A is another environmental perspective view of a worker installing the support member from FIG. 2 on the roof of a steel building showing the worker connecting the bracing strut to the vertical main support post via the bracing connection at the connection point;

FIG. 7B is a perspective view of the support member with the vertical main support post reinforce by the bracing strut from FIG. 2 showing how the worker from FIG. 7A interconnects the bracing strut between the vertical main support post and the bracing base via the bracing bolts;

FIG. 8 is another environmental perspective view of a worker installing the with the vertical main support post reinforce by the bracing strut from FIG. 2 on the roof of a steel building showing the worker connecting the bracing strut from the vertical main support post to the bracing base via the bracing bolts;

FIG. 9 is an environmental perspective view of the fall protection cable system configured to create a controlled access zone for working on the roof on steel buildings according to select embodiments of the instant disclosure showing a corner support member with two bracing struts attached thereto for reinforcing the vertical main support post in two reinforcing directions;

FIG. 10 is an environmental perspective view of the fall protection cable system configured to create a controlled access zone for working on a roof of a steel building according to select embodiments of the instant disclosure showing the full system installed on the roof of a metal building and the controlled access zone created therefrom;

FIG. 11 is an environmental side view of the fall protection cable system configured to create a controlled access zone for working on the roof of the steel building according to select embodiments of the instant disclosure showing roofing installers tied off on the cable of the fall protection system with one of the roofing installers load being supported by the fall protection cable;

FIG. 12 is a perspective side view of a support member with a vertical main support post reinforced by a bracing strut according to select embodiments of the instant disclosure for the fall protection cable system configured to create a controlled access zone on the roof of a steel building, with cable mounting flange positioned on the main support post at a shortened elevation position for supporting the cable at the shortened elevation position;

FIG. 13 is an environmental perspective view of the fall protection cable system configured to create a controlled access zone for working on a roof of a steel buildings according to select embodiments of the instant disclosure showing the full system installed on the roof of a metal building and the controlled access zone created therefrom, where the controlled access zone is created via the boundary line through the passage at the distal end of the vertical main support posts and the fall protection system created via the fall protection cable interconnected through the holes in the cable mounting flanges in the shortened elevation position of the vertical main support posts; and

FIG. 14 is a flow chart of the method of working on the roof of a steel building according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

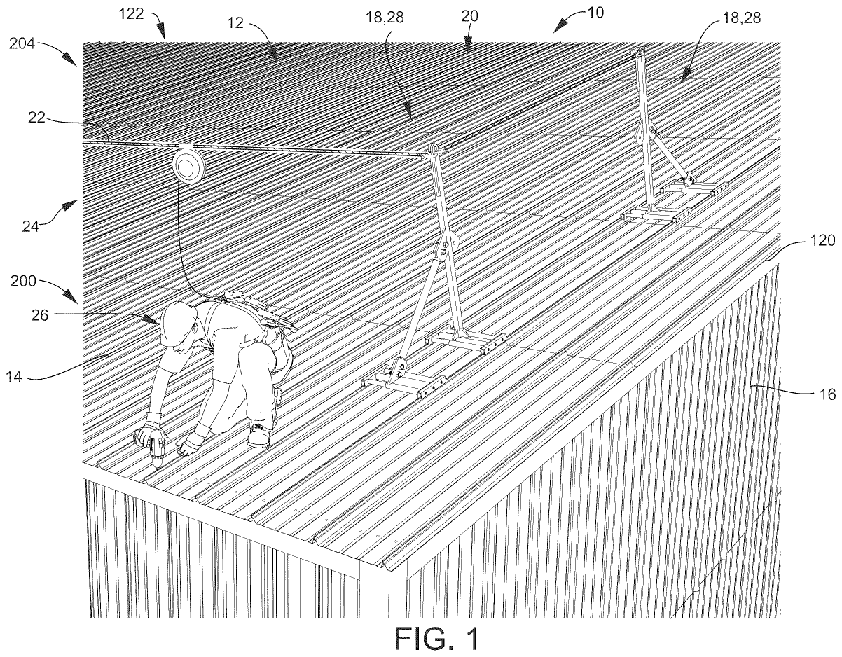

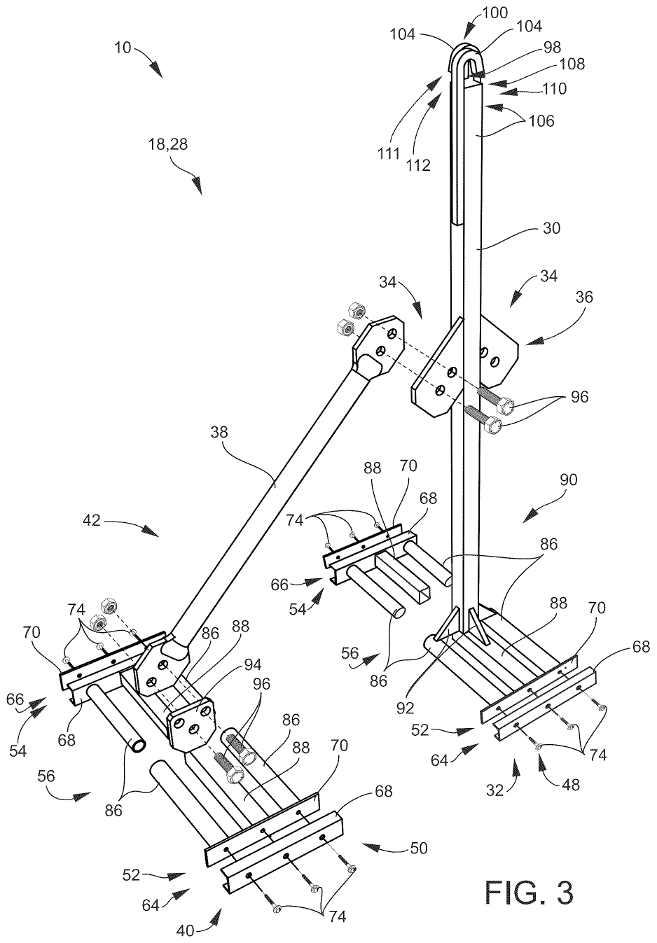

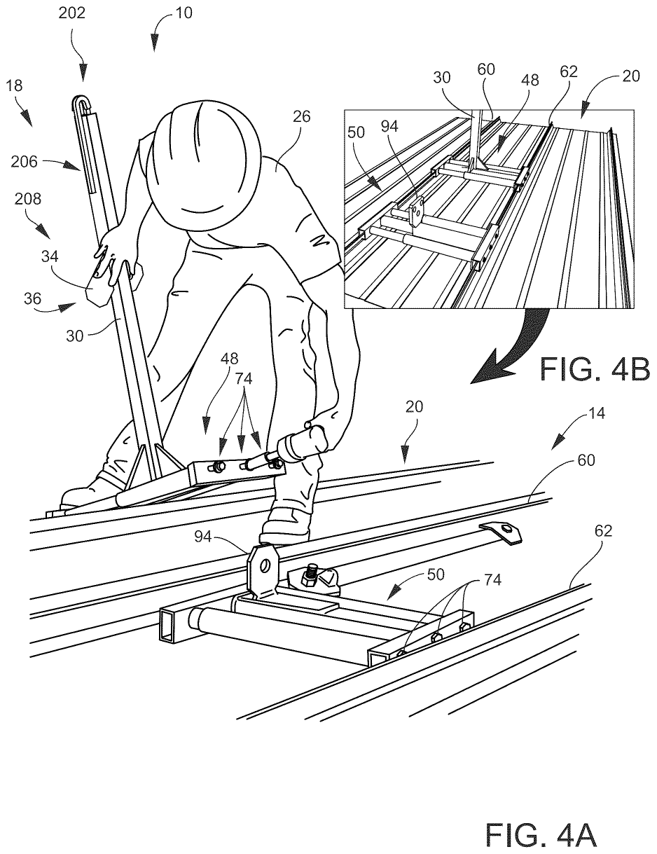

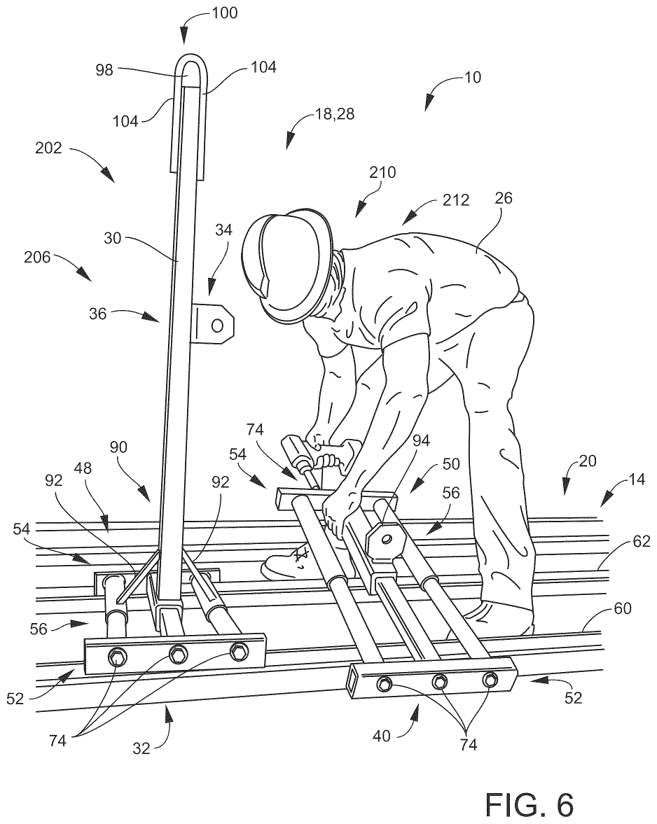

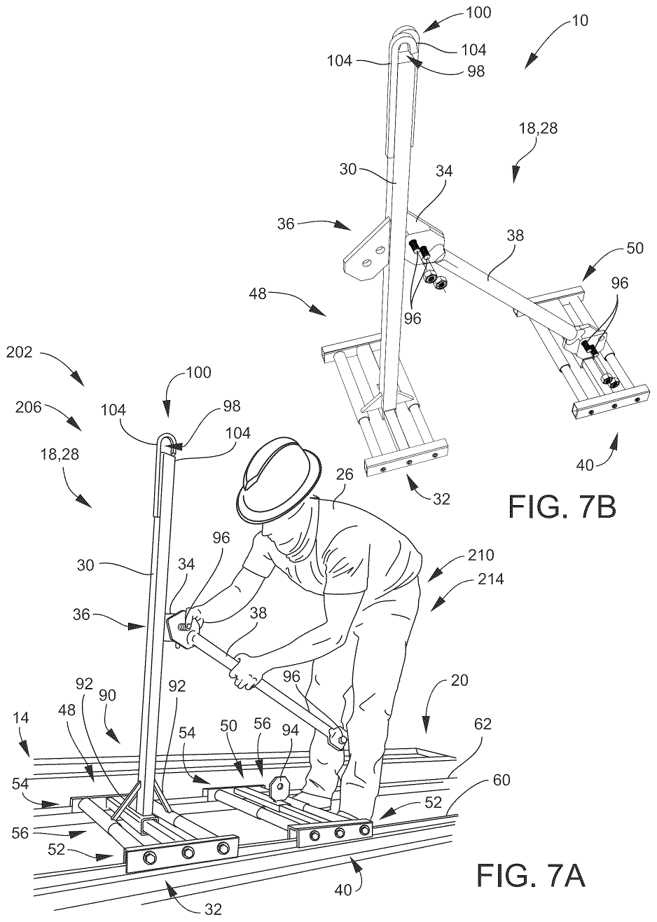

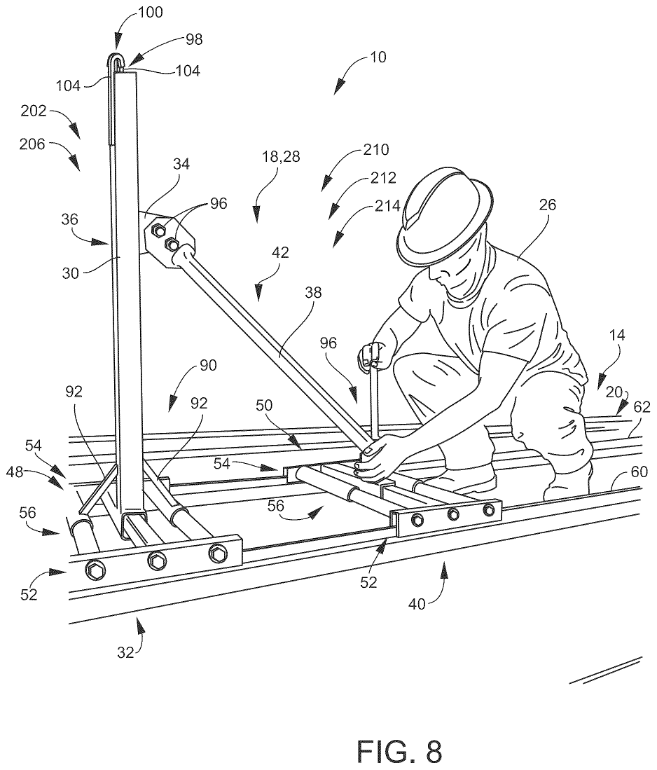

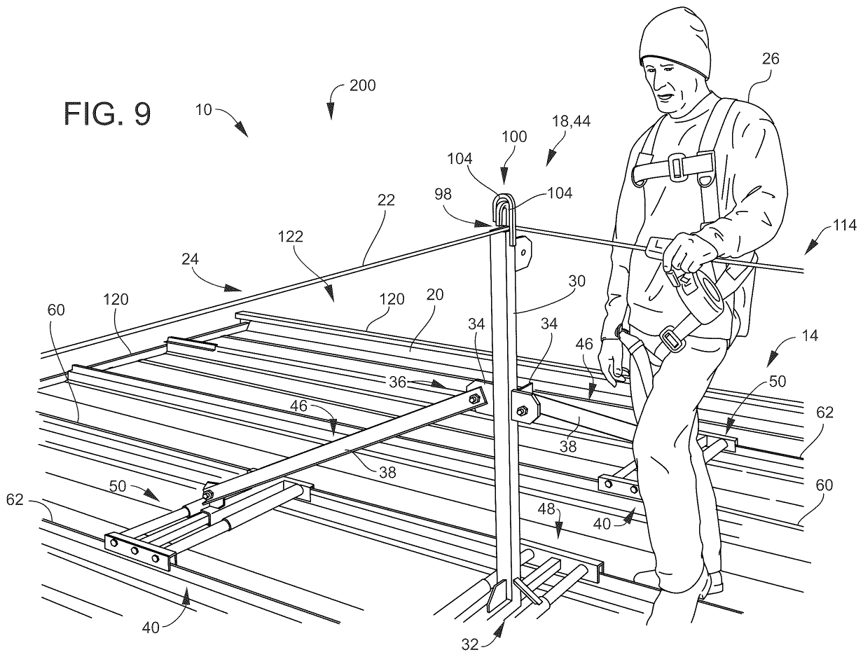

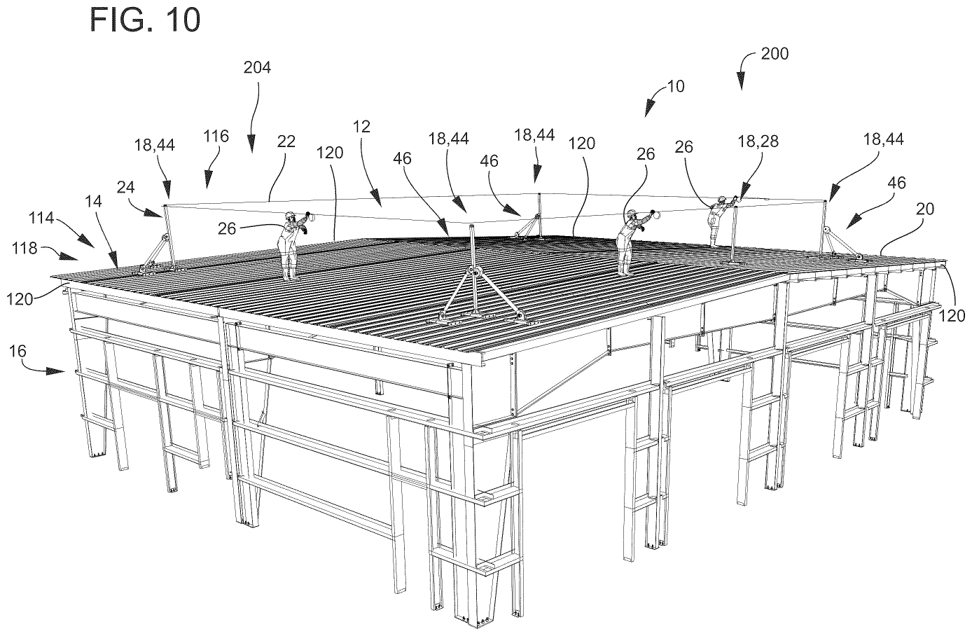

Referring now to FIGS. 1-14, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-13, in select possibly preferred embodiments, the present disclosure overcomes the above-mentioned disadvantages and meets the recognized need for such an apparatus or method by providing of fall protection cable system 10 with controlled access zone 12 for working on roof 14 of steel building 16, or the like. This fall protection cable system 10 with controlled access zone 12 may be used for various or any roof installation purposes and other types of work on the tops of an installed roof on any type of building, including, but not limited to various steel buildings, or the like, as shown in FIGS. 1, 4-11, and 13. Fall protection cable system 10 with controlled access zone 12 for working on roof 14 of steel building 16, and method of use and installation thereof, may generally include a plurality of support members 18. Each support member 18 may be configured to attach to top 20 of roof 14 on the steel building 16. Fall protection cable 22 may be interconnected between each of the plurality of support members 18 at elevated position 24 above top 20 of roof 14 on the steel building 16. Wherein, the fall protection cable 22 may be configured for allowing worker 26, or a plurality of workers 26, to tie off to fall protection cable 22 at elevated position 24 above top 20 of roof 14 while working on top 20 of roof 14. Workers 26 may tie off to fall protection cable 22 by any known safety measures, including, but not limited to, any personal protective equipment. In select embodiments, the personal protective equipment may include, but is not limited to, a harness, a lanyard, and a retractable lanyard.

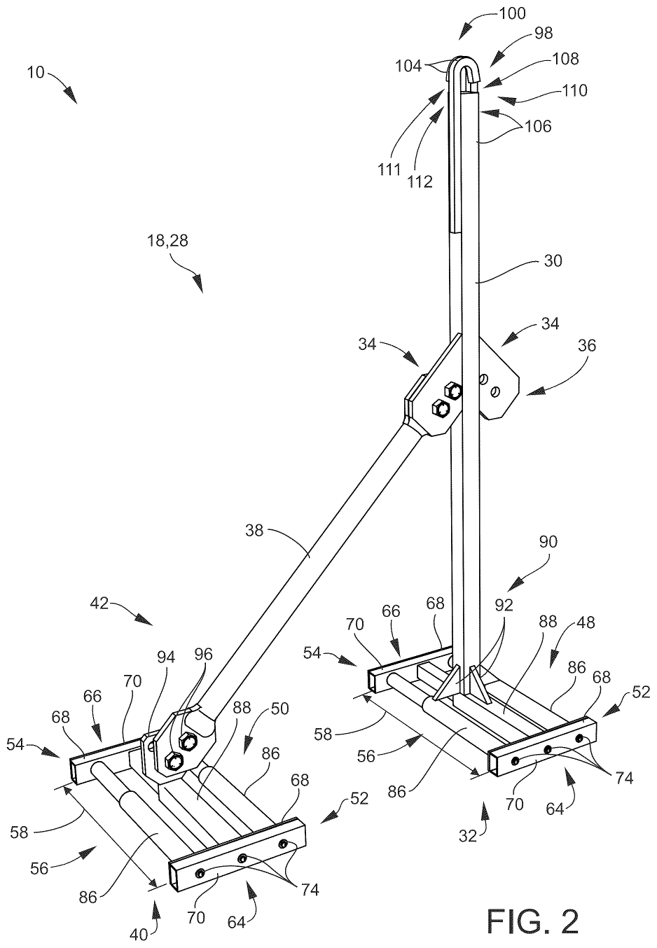

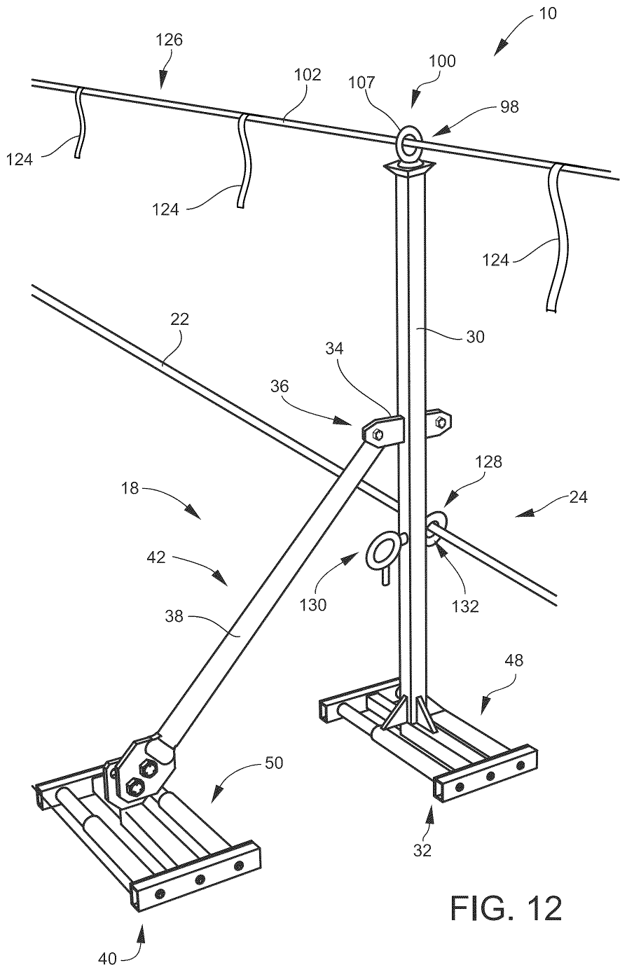

Referring now specifically to FIG. 2, in select embodiments of fall protection cable system 10, the plurality of support members 18 may include at least one standard support member 28. Each of the at least one standard support member 28 may include vertical main support post 30 and bracing strut 38. Vertical main support post 30 may be configured to be attached to top 20 of roof 14 of steel building 16 at main support location 32. Vertical main support post 30 may include bracing connection 34 affixed at connection point 36 on vertical main support post 30. Connection point 36 may be any desired height on vertical main support post 30, including, but not limited to approximately or equal to the mid point of vertical main support post 30, approximately or equal to ⅔ up vertical main support post 30, or the like. This embodiment may provide the optimum support to vertical main support post 30 from bracing strut 38. Bracing strut 38 may be configured to be attached to top 20 of roof 14 of steel building 16 at bracing support location 40. Bracing strut 38 may be configured to be interconnected between top 20 of roof 14 at bracing support location 40 and bracing connection 34 affixed to vertical main support post 30 at connection point 36. Wherein, vertical main support post 30 may be reinforced in reinforcing direction 42 by bracing strut 38. In select possibly preferred embodiments, vertical main support post 30 of the standard support members 28 may be reinforced in perpendicular reinforcing direction 42 to provide perpendicular support on fall protection cable 22, as shown in the Figures. In select possibly preferred embodiments, connection point 36 and bracing strut 38 may be sized and configured to provide 45 degree angles (or approximate thereto) between bracing strut 38 and vertical main support post 30, and between bracing strut 38 and top 20 of roof 14. Bracing connection 34 may be a flange or the like attached to vertical support post 30 with bolt holes therethrough configured for connecting bracing strut 38. In select embodiments, as shown in FIG. 2, bracing connection 34 may be angled to match the angle of bracing strut 38. As shown in these embodiments, in select embodiments, bracing connection 34 may include multiple, (like 2) bolt holes therethrough configured for connecting bracing strut 38. In other select embodiments, as shown in FIG. 12, bracing connection 34 may be perpendicular with vertical main support post 30. As shown in these embodiments, in select embodiments, bracing connection 34 may include a single bolt hole therethrough configured for connecting bracing strut 38. This embodiment may allow for more flexibility in the angle of bracing strut 38, thereby, providing for easier installation and mounting of the support members 18.

Referring now specifically to FIGS. 1, 9, 10 and 13, in other select embodiments of fall protection cable system 10, the plurality of support members 18 may include at least one corner support member 44. Each of the at least one corner support member 44 may include vertical main support post 30 and two bracing struts 38. As with standard support member 28, vertical main support post 30 may be configured to be attached to top 20 of roof 14 of steel building 16 at main support location 32. But vertical main support post 30 of corner support member 44 may include two bracing connections 34 affixed at connection point 36 on vertical main support post 30 of each corner support member 44. The two bracing struts 38 may be configured to be attached to top 20 of roof 14 of steel building 16 at two bracing support locations 40. One of the two bracing struts 38 may be configured to be interconnected between the top 20 of roof 14 at one of the two bracing support locations 40 and one of the two bracing connections 34 affixed to the vertical main support post 30 at the connection point 36. The other of the two bracing struts 38 may be configured to be interconnected between the top 20 of roof 14 at the other of the two bracing support locations 40 and the other of the two bracing connections 34 affixed to the vertical main support post 30 at connection point 36. Wherein, the vertical main support post 30 of the corner support members 44 may be reinforced in two reinforcing directions 46 by the two bracing struts 38. In select possibly preferred embodiments, vertical main support post 30 of the corner support members 44 may be reinforced in two perpendicular reinforcing directions 46 to be provide perpendicular support on fall protection cable 22 the corner of the controlled access zone 12 of fall protection system 10.

As shown in the Figures, and clearly not limited thereto, in select embodiments of the disclosed fall protection cable system 10, vertical main support post 30 may include main base 48. Main base 48 may be configured to attach vertical main support post 30 to top 20 of roof 14 of steel building 16 at main support location 32.

As shown in the Figures, and clearly not limited thereto, in select embodiments of the disclosed fall protection cable system 10, bracing strut 38 may include bracing base 50. Bracing base 50 may be configured to attach bracing strut 38 to top 20 of roof 14 of steel building 16 at bracing support location 40.

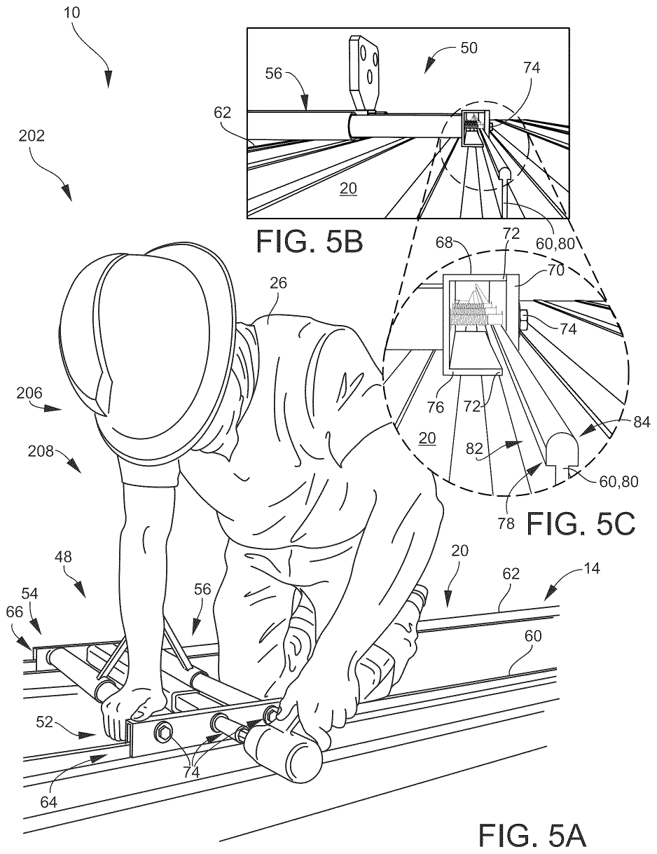

As shown in the Figures, in select embodiments of fall protection cable system 10, main base 48 and/or bracing base 50 may include first connecting side 52, second connecting side 54, and least one telescoping member 56. The at least one telescoping member 56 may be interconnected between first connecting side 52 and second connecting side 54. Wherein, base width 58 between first connecting side 52 and second connecting side 54 may be configured to be adjustable to fit first connecting side 52 on first seam 60 of roof 14 and second connecting side 54 on an adjacent second seam 62 of roof 14. In select embodiments, first connecting side 52 may include first clamp 64 configured to affix first connecting side 52 on first seam 60 of roof 14, and/or second connecting side 54 may include second clamp 66 configured to affix second connecting side 54 on adjacent second seam 62 of roof 14. As best shown in FIGS. 5B and 5C, in select embodiments, first clamp 64 and second clamp 66 of each of main base 48 and bracing base 50 may include C-channel bracket 68 and flat bracket 70. Flat bracket 70 may be adjustably attached to ends 72 of C-channel bracket 68 via at least one clamp screw 74. Wherein, when bottom member 76 of C-channel bracket 68 is positioned below lip 78 of seam 80 of roof 14 on first seam side 82 of seam 80 and flat bracket 70 is positioned on second seam side 84 of seam 80, and each of the at least one clamp screw 74 is tightened, flat bracket 70 and bottom member 76 of C-channel bracket 68 may be compressed together to lock onto seam 80 with bottom member 76 of C-channel bracket 68 locked in position below lip 78 of seam 80 of roof 14 on first seam side 82 of seam 80. In select possibly preferred embodiments, as shown in Figures, and clearly not limited thereto, flat bracket 70 may be adjustably attached to ends 72 of C-channel bracket 68 via three clamp screws 74.

As shown in the Figures, and clearly not limited thereto, in select embodiments of the disclosed fall protection cable system 10, main base 48 and/or bracing base 50 may include three telescoping members 56 interconnected between first connecting side 52 and second connecting side 54. In select embodiments, main base 48 and/or bracing base 50 may include two outer circular telescoping members 86 and inner rectangular telescoping member 88. The two outer circular telescoping members 86 may be interconnected between first connecting side 52 and second connecting side 54. Although the two outer circular telescoping members 86 are shown and discussed as round or circular, the disclosure is not so limited, and the two outer circular telescoping members 86 may be other shapes, including, but not limited to, square, rectangular, triangular, the like, etc. Likewise, although the inner rectangular telescoping member 88 is shown and discussed as rectangular or square, the disclosure is not so limited, and the inner rectangular telescoping member 88 may be other shapes, including, but not limited to, circular, triangular, the like, etc. The inner rectangular telescoping member 88 may be interconnected between first connecting side 52 and second connecting side 54. The inner rectangular telescoping member 88 may be positioned between the two outer circular telescoping members 86. Inner rectangular telescoping member 88 may be configured to provide a flat surface for mounting vertical main support post 30 to main base 48 and/or for bracing strut 38 to bracing base 50. In select embodiments, main base 48 may include vertical main support post 30 being affixed to inner rectangular telescoping member 88. In these embodiments, vertical main support post 30 may be supported in perpendicular orientation 90 to inner rectangular telescoping member 88 via a plurality of support wedges 92. In select embodiments, bracing base 50 may include bracing flange 94. Bracing flange 94 may be affixed to inner rectangular telescoping member 88. Bracing strut 38 may be removably affixed to bracing flange 94 on inner rectangular telescoping member 88 via a plurality of bracing bolts 96. Bracing bolts 96 may also be used to affix bracing strut 38 to bracing connection 34 on vertical main support post 30.

As shown in the Figures, one feature of the disclosed fall protection cable system 10 may be that vertical main support post 30 of each of the plurality of support members 18 may include passage 98 at distal end 100. Passage 98 at distal end 100 of vertical main support post 30 of each of the plurality of support members 18 may be for receiving and holding fall support cable 22 for tying off workers, and/or for receiving and holding boundary line 102 for creating controlled access zone 12 on top 20 of roof 14 of steel building 16. As such, passage 98 at distal end 100 of vertical main support post 30 of each of the plurality of support members 18 may be configured to receive fall protection cable 22 and/or boundary line 102 therethrough for supporting fall protection cable 22 and/or boundary line 102 above roof 14. Boundary line 102 may be made from any material for creating controlled access zone 12 on top 20 of roof 14 of steel building 16. As examples, and clearly not limited thereto, boundary line 102 may be a cable, a rope, a cord, or the like configured to create controlled access zone 12 on top 20 of roof 14 of steel building 16. Under OSHA standards, boundary line 102 may be required to support 200 pounds. As such, in select embodiments, the cable, rope, cord, or the like used for boundary line 102 may be configured and designed to hold 200 pounds or more. In select embodiments, as shown in FIGS. 2-4, 6, 7, 8 and 9, and clearly not limited thereto, passage 98 may be created on distal end 100 of vertical main support post 30 via two hook members 104. The two hook members 104 may be affixed to distal end 100 of vertical main support post 30 on opposing sides 106 of distal end 100 of vertical main support post 30. One of the two hook members 104 may have first opening 108 facing first direction 110, and the other of the two hook members 104 may have second opening 111 facing second direction 112 that is opposite of first direction 110 of first opening 108. This configuration of the two hook members 104 may allow the fall support cable 22 and/or boundary line 102 to be weaved between the two opposing hook members 104. As shown in FIG. 12, in other select embodiments, passage 98 may be created on distal end 100 of vertical main support post 30 via eyebolt 107. Eyebolt 107, or eyelet bolt 107, may be affixed or screwed in to distal end 100 of vertical support post 30. Eyebolt 107 may have a hole therethrough configured for receiving fall protection cable 22 and/or boundary line 102 therethrough. As examples, and clearly not limited thereto, eyebolt 107 may be a ¾ inch eyebolt. Passage 98 may provide for holding fall protection cable 22 and/or boundary line 102 at elevated position above top 20 of roof 14 for creating controlled access zone 12. Elevated position of passage 98 may be any desired height above top 20 of roof 14, including, but not limited to, providing a height configured to meet OSHA standards for creating controlled access zone 12. As such, passage 98 may be positioned whereby the lowest point (including sagging) of fall protection cable 22 and/or boundary line 102 must be at least 39 inches above top 20 of roof 14 and no higher than 45 inches. In select possibly preferred embodiments, elevated position of passage 98 may be 42 inches above top 20 of roof 14.

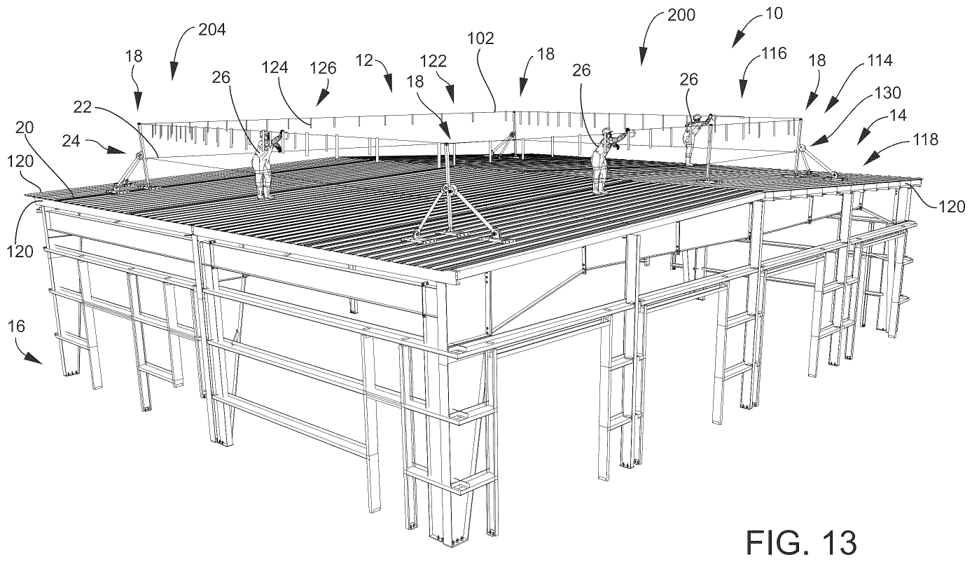

As best shown in FIGS. 1, 10, 11 and 13, another feature of the disclosed fall protection cable system 10 may be that fall protection cable system 10 can be configured to create controlled access zone 12. Controlled access zone 12 or CAZ 12 may be created via fall protection cable 22 (see FIGS. 1, 10 and 11) and/or boundary line 102 (see FIG. 13) being interconnected between each of the plurality of support members 18 positioned on roof 14 of steel building 16. In select embodiments, the plurality of support members 18 may be positioned around perimeter 114 of roof 14. The plurality of support members 18 may be positioned around perimeter 114 of roof 14 at set separation distance apart 116 and/or at set offset distance 118 from edge 120 of roof 14. Set separation distance apart 116 and/or set offset distance 118 from edge 120 of roof 14 may be any desired distances, including, but not limited to, distances to conform to OSHA standards. As such, in select embodiments, set distance apart may be configured to withstand 200 pounds of weight on fall protection cable 22 and/or boundary line 102. In select embodiments, set offset distance 118 from edge 120 of roof 14 may be between 6 feet and 25 feet. Whereby, controlled access zone 12 may be enclosed area 122 on top 20 of roof 14 defined by fall protection cable 22 and/or boundary line 102 interconnected between each of the plurality of support members 18 positioned around perimeter 114 of roof 14.

As shown in FIGS. 12 and 13, another feature of the disclosed fall protection cable system 10 may be that fall protection cable 22 and/or boundary line 102 interconnected between each of the plurality of support members 18 may include flags or streamers 124 attached thereto. The flags or streamers 124 may be attached on fall protection cable 22 and/or boundary line 102 a set visibility distance 126 a part. The flags or streamers 124 on fall protection cable 22 and/or boundary line 102 may be configured to provide visibility to fall protection cable 22 and/or boundary line 102 for clearly defining controlled access zone 12. Set visibility distance 126 between each flag or streamer 124 attached on fall support cable 22 and/or boundary line 102 may be any desired distance, including, but not limited to distances to conform to OSHA standards. As such, in select embodiments, set visibility distance 126 between each flag or streamer 124 may be less than or equal to 6 feet.

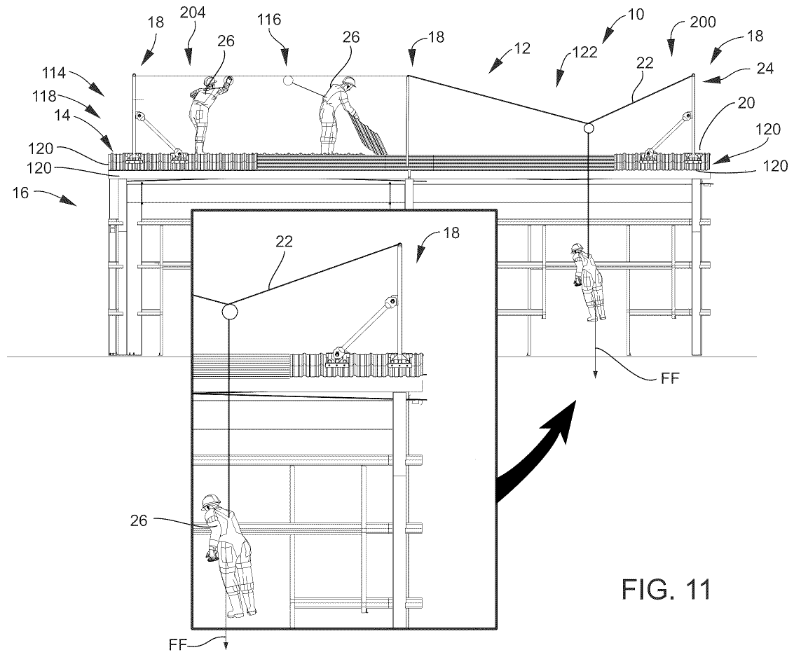

Referring now specifically to FIGS. 12 and 13, in select embodiments of the disclosed fall protection cable system 10, vertical main support post 30 of each of the plurality of support members 18 may include cable mounting flange 128. Cable mounting flange 128 may be affixed at shortened elevated position 130 on vertical main support post 30 of each of the plurality of support members 18. Cable mounting flange 128 may include hole 132 therethrough configured to receive fall protection cable 22. In select embodiments, as shown in FIG. 12, cable mounting flange 128 may be an eyebolt or eyelet bolt with hole 132 therethrough. In these embodiments with the shortened elevated position 130 for fall protection cable 22, fall protection cable system 10 may be configured to create controlled access zone 12 via boundary line 102 being interconnected between each of the plurality of support members 18 at passage 98 on distal end 100 of vertical main support post 30 of each of the plurality of support members 18. In addition, fall protection cable system 10 may be configured to allow worker(s) 26 to tie off to fall protection cable 22 at shortened elevated position 130 via fall protection cable 22 being interconnected between each of the plurality of support members 18 through hole 132 in cable mounting flange 128 affixed on vertical main support post 30 of each of the plurality of support members 18. This embodiment may provide more strength to fall protection cable 22 as the strength of vertical main support post 30 provided to fall protection cable 22 at shortened elevated position 130 is greater than at distal end 100 with passage 98. Fall protection cable system 10 may be designed and configured for any desired falling force FF strength for workers 26 (see FIG. 11) provided by fall protection cable 22. In select embodiments, and clearly not limited thereto, fall protection system 10 may be designed and configured to meet OSHA standards. As such, in select embodiments, fall protection cable system 10 may be designed and configured for falling force FF strength for workers 26 to be at least 5,000 pounds provided by fall protection cable 22. As such, in these embodiments, each anchor or base must provide at least 5,000 pounds of strength for fall protection cable 22.

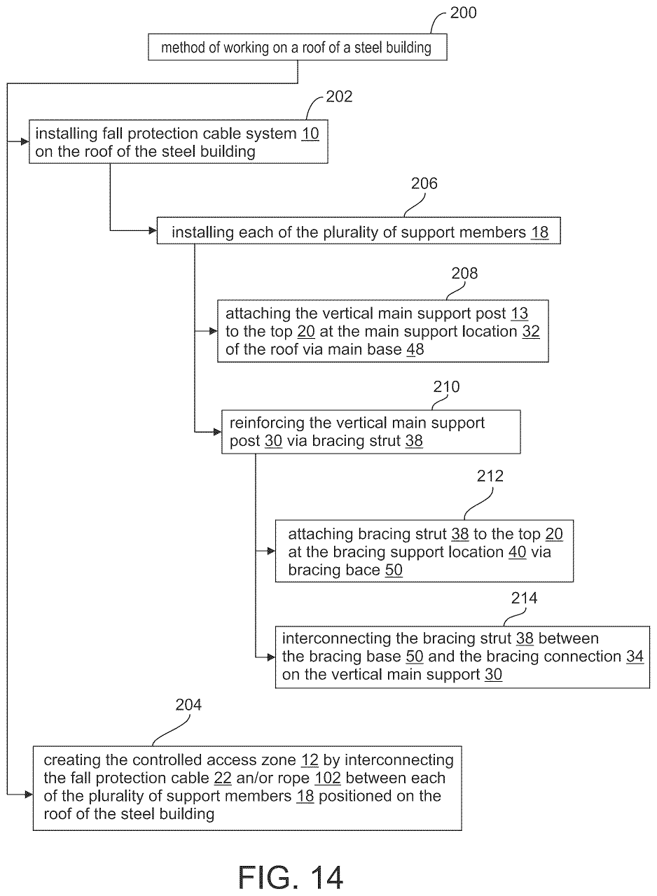

Referring now to FIG. 14, in another aspect, the instant disclosure embraces method 200 of working on roof 14 of steel building 16, or the like. Method 200 of working on roof 14 of steel building 16 may generally include utilizing the disclosed fall protection cable system 10 configured for creating controlled access zone 12 on roof 14 of steel building 16 in any of the embodiments and/or combinations of embodiments shown and/or described herein. As such, the disclosed method 200 of working on roof 14 of steel building 16 may include step 202 of installing fall protection cable system 10 on roof 14 of steel building 16. The installed fall protection cable system 10 installed may generally include: a plurality of support members 18, each support member 18 may be configured to attach to top 20 of roof 14 on steel building 16; fall protection cable 22 interconnected between each of the plurality of support members 18 at elevated position 24 above top 20 of roof 14 on steel building 16; wherein fall protection cable 22 is configured for allowing worker 26 to tie off to fall protection cable 22 at elevated position 24 above roof 14 while working on roof 14. With the fall protection cable system 10 installed, the disclosed method 200 of working on roof 14 of steel building 16 may further include step 204 of creating controlled access zone 12 by interconnecting fall protection cable 22 and/or boundary line 102 between each of the plurality of support members 18 positioned on roof 14 of steel building 16.

Still referring specifically to FIG. 14, in select embodiments of the disclosed method 200 of working on roof 14 of steel building 16, wherein each of the plurality of support members 18 of the fall protection cable system 10 further include: vertical main support post 30 configured to be attached to top 20 of roof 14 of steel building 16 at main support location 32, the vertical main support post 30 including bracing connection 34 affixed at connection point 36 on vertical main support post 30; bracing strut 38 configured to be attached to top 20 of roof 14 of steel building 16 at bracing support location 40; wherein, bracing strut 38 is configured to be interconnected between top 20 of roof 14 at bracing support location 40 and bracing connection 34 affixed to vertical main support post 30 at connection point 36; and whereby, vertical main support post 30 is reinforced in reinforcing direction 42 by bracing strut 38. In these embodiments, step 202 of installing of the fall protection cable system 10 on roof 14 of steel building 16 may include step 206 of installing each of the plurality of support members 18. This step 206 of the installation of each of the plurality of support members 18 may include: step 208 of attaching the vertical main support post 30 to the top 20 at the main support location 32 of the roof 14 via main base 48; and step 210 of reinforcing the vertical main support post 30 via the bracing strut 38 by step 212 of attaching the bracing strut 38 to the top 20 at the bracing support location 40 via bracing base 50, and step 214 of interconnecting the bracing strut 38 between bracing base 50 and bracing connection 34 on vertical main support post 30.

In sum, the purpose of the disclosed fall protection cable system 10 configured to create controlled access zone 12 on roof 14 of steel building 16 may be to provide a fall support cable at 42 inches above the roof area that gives fall protection to workers 26. The disclosed system 10 may serve two purposes: it establishes controlled access zone 12 per OSHA and may provide fall protection that meets OSHA standards.

A feature of the disclosed fall protection cable system 10 configured for creating controlled access zone 12 on roof 14 of steel building 16 may be its ability to clamp to standing seam roofs from 16 inches to 24 inches wide without damaging the panels.

Another feature of the disclosed fall protection cable system 10 configured for creating controlled access zone 12 on roof 14 of steel building 16 may be its ability to allow fall protection cable 22 to be pulled at 42 inches above finished floor (“AFF”) around the entire perimeter 114 of the roof 14.

Another feature of the disclosed fall protection cable system 10 configured for creating controlled access zone 12 on roof 14 of steel building 16 may be its ability to give 5,000 pounds of strength at each anchor, which may meet OSHA standards.

Another feature of the disclosed fall protection cable system 10 configured for creating controlled access zone 12 on roof 14 of steel building 16 may be that it can provide shortened elevated position 130 of fall protection cable 22 of approximately 24 inches above the roof deck (top 20 of the roof) and pull boundary line 102 at the current 42 inches of passage 98 at distal end 100 of vertical main support post 30. This clarifies the CAZ 12 per OSHA standards and increases the anchor strength of fall protection cable 22.

The purpose of the disclosed fall protection cable system 10 may be two folds. First, system 10 can be configured for creating controlled access zone 12 on roof 14 of steel building 16. After the roof has been installed (like on a standing seam roof, either trapezoidal or T lock) fall protection cable system 10 may provide both the perimeter boundary marking the CAZ 12 and fall protection outside CAZ 12. It accomplishes this by the anchoring a plurality of support members 18 that are spread across the roof 14 at roughly 50′ increments and 8-10′ from all edges 120. The fall protection cable 22 (either 5/16 or ⅜) may be pulled at 42″ above the roof deck or top 20. The workers 26 inside fall protection cable 22 are within the controlled access zone (CAZ) 12 and are therefore not required to be tied off per OSHA regulations. The workers 26 outside the controlled access zone 12 and working on edges 120 can connect their lanyards to the fall protection cable 22 and thereby achieve 100% tie-off.

An important feature of the disclosed fall protection cable system 10 configured for creating controlled access zone 12 on roof 14 of steel building 16 may be that it is designed and configured to clamp to trapezoidal standing seam roofs, or other standing seam style roofs (which is a flat panel with straight vertical ribs) without damaging the panels or making penetrations through the roof panels that later have to be repaired. The clamps (64 and 66) of the main base 48 and bracing base 50 are adjustable to work on 16″-24″ standing seam panels. They also reach the required anchor strength whether the roof has been seamed or not. This feature may be really important so that the workers running the seaming tool stay tied off (other anchors on the market are on the roof and therefore they create a trip hazard for the worker. Also, the anchors have to be moved when the work has exceeded the lanyards distance; so it cannot be 100% tie-off). The disclosed fall protection cable system 10 configured for creating controlled access zone 12 on roof 14 of steel building 16 may be a continuous cable for the entire perimeter 114 and it may be at 42″, making movement around and through very easy.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

1. A fall protection cable system for a roof on a steel building comprising:
a plurality of support members, each support member is configured to attach to a top of the roof on the steel building;
a fall protection cable interconnected between each of the plurality of support members at an elevated position above the top of the roof on the steel building; and
wherein the fall protection cable is configured for allowing a worker to tie off to the fall protection cable at the elevated position above the top of the roof while working on the top of the roof.

2. The fall protection cable system according to claim 1, wherein the plurality of support members including at least one standard support member, each of the at least one standard support member including:
a vertical main support post configured to be attached to the top of the roof of the steel building at a main support location, the vertical main support post including a bracing connection affixed at a connection point on the vertical main support post;
a bracing strut configured to be attached to the top of the roof of the steel building at a bracing support location;
the bracing strut is configured to be interconnected between the top of the roof at the bracing support location and the bracing connection affixed to the vertical main support post at the connection point; and
wherein, the vertical main support post is reinforced in a reinforcing direction by the bracing strut.

3. The fall protection cable system according to claim 2, wherein the plurality of support members including at least one corner support member, each of the at least one corner support member including:
the vertical main support post configured to be attached to the top of the roof of the steel building at the main support location, the vertical main support post including two of the bracing connections affixed at the connection point on the vertical main support post;
two of the bracing struts configured to be attached to the top of the roof of the steel building at two of the bracing support locations, one of the two bracing struts is configured to be interconnected between the top of the roof at one of the two bracing support locations and one of the two bracing connections affixed to the vertical main support post at the connection point, and the other of the two bracing struts is configured to be interconnected between the top of the roof at the other of the two bracing support locations and the other of the two bracing connections affixed to the vertical main support post at the connection point; and
wherein, the vertical main support post is reinforced in two of the reinforcing directions by the two bracing struts.

4. The fall protection cable system according to claim 2, wherein:
the vertical main support post including a main base configured to attach the vertical main support post to the top of the roof of the steel building at the main support location; and
the bracing strut including a bracing base configured to attach the bracing strut to the top of the roof of the steel building at the bracing support location.

5. The fall protection cable system according to claim 4, wherein the main base and the bracing base comprising:
a first connecting side;
a second connecting side;
at least one telescoping member interconnected between the first connecting side and the second connecting side; and
wherein a base width between the first connecting side and the second connecting side is configured to be adjustable to fit the first connecting side on a first seam of the roof and the second connecting side on an adjacent second seam of the roof.

6. The fall protection cable system according to claim 5, wherein:
the first connecting side including a first clamp configured to affix the first connecting side on the first seam of the roof; and
the second connecting side including a second clamp configured to affix the second connecting side on the adjacent second seam of the roof.

7. The fall protection cable system according to claim 6, wherein the first clamp and the second clamp of each of the main base and the bracing base including:
a C-channel bracket;
a flat bracket adjustably attached to ends of the C-channel bracket via at least one clamp screw; and
wherein, when a bottom member of the C-channel bracket is positioned below a lip of a seam of the roof on a first seam side of the seam and the flat bracket is positioned on a second seam side of the seam, and each of the at least one clamp screw is tightened, the flat bracket and the bottom member of the C-channel bracket are compressed together to lock onto the seam with the bottom member of the C-channel bracket locked in position below the lip of the seam of the roof on the first seam side of the seam.

8. The fall protection cable system according to claim 7, wherein the flat bracket is adjustably attached to the ends of the C-channel bracket via three clamp screws.

9. The fall protection cable system according to claim 5, wherein the main base and the bracing base including three telescoping members interconnected between the first connecting side and the second connecting side.

10. The fall protection cable system according to claim 8, wherein the main base and the bracing base including:
two outer circular telescoping members interconnected between the first connecting side and the second connecting side; and
an inner rectangular telescoping member interconnected between the first connecting side and the second connecting side, the inner rectangular telescoping member is positioned between the two outer circular telescoping members.

11. The fall protection cable system according to claim 10, wherein:
the main base including the vertical main support post being affixed to the inner rectangular telescoping member and being supported in a perpendicular orientation to the inner rectangular telescoping member via a plurality of support wedges; and
the bracing base including a bracing flange affixed to the inner rectangular telescoping member, where the bracing strut is removably affixed to the bracing flange on the inner rectangular telescoping member via a plurality of bracing bolts.

12. The fall protection cable system according to claim 2, wherein the vertical main support post of each of the plurality of support members including a passage at a distal end, where the passage at the distal end of the vertical main support post of each of the plurality of support members is configured to receive the fall protection cable or a boundary line therethrough for supporting the fall protection cable or the boundary line above the roof; and
wherein, the passage is created on the distal end of the vertical main support post via two hook members or an eyebolt affixed to the distal end of the vertical main support post on opposing sides of the distal end of the vertical main support post, wherein one of the two hook members has a first opening facing a first direction, and the other of the two hook members has a second opening facing a second direction that is opposite of the first direction of the first opening.

13. The fall protection cable system according to claim 12, wherein the fall protection cable system is configured to create a controlled access zone via the fall protection cable or the boundary line being interconnected between each of the plurality of support members positioned on the roof of the steel building.

14. The fall protection cable system according to claim 13, wherein the plurality of support members are positioned around a perimeter of the roof a set separation distance apart and a set offset distance from an edge of the roof, whereby the controlled access zone is an enclosed area on the top of the roof defined by the fall protection cable or the boundary line interconnected between each of the plurality of support members positioned around the perimeter of the roof.

15. The fall protection cable system according to claim 14, wherein the fall protection cable or the boundary line including flags or streamers attached thereto a set visibility distance a part, the flags or streamers on the fall protection cable or boundary line are configured to provide visibility to the fall protection cable or the boundary line defining the controlled access zone.

16. The fall protection cable system according to claim 12, wherein the vertical main support post of each of the plurality of support members including a cable mounting flange affixed at a shortened elevated position on the vertical main support post, the cable mounting flange including a hole therethrough configured to receive the fall protection cable.

17. The fall protection cable system according to claim 16, wherein:
the fall protection cable system is configured to create a controlled access zone via the boundary line being interconnected between each of the plurality of support members at the passage on the distal end of the vertical main support post of each of the plurality of support members; and
the fall protection cable system is configured to allow the worker to tie off to the fall protection cable at the shortened elevated position via the fall protection cable being interconnected between each of the plurality of support members through the hole in the cable mounting flange affixed on the vertical main support post of each of the plurality of support members.

18. A fall protection cable system configured for creating a controlled access zone on a roof of a steel building comprising:
a plurality of support members, each support member is configured to attach to a top of the roof on the steel building;
a fall protection cable interconnected between each of the plurality of support members at an elevated position above the top of the roof on the steel building;
wherein the fall protection cable is configured for allowing a worker to tie off to the fall protection cable at the elevated position above the top of the roof while working on the top of the roof; and
wherein the fall protection cable system is configured to create the controlled access zone via the fall protection cable or a boundary line being interconnected between each of the plurality of support members positioned on the roof of the steel building.

19. A method of working on a roof of a steel building comprising:
installing a fall protection cable system on the roof of the steel building, the fall protection cable system comprising:
a plurality of support members, each support member is configured to attach to a top of the roof on the steel building;
a fall protection cable interconnected between each of the plurality of support members at an elevated position above the top of the roof on the steel building;
wherein the fall protection cable is configured for allowing a worker to tie off to the fall protection cable at the elevated position above the roof while working on the roof; and
creating a controlled access zone by interconnecting the fall protection cable or a boundary line between each of the plurality of support members positioned on the roof of the steel building.

20. The method of working on the roof of a steel building of claim 19, wherein each of the plurality of support members of the fall protection cable system further including:
a vertical main support post configured to be attached to the top of the roof of the steel building at a main support location, the vertical main support post including a bracing connection affixed at a connection point on the vertical main support post;
a bracing strut configured to be attached to the top of the roof of the steel building at a bracing support location;
the bracing strut is configured to be interconnected between the top of the roof at the bracing support location and the bracing connection affixed to the vertical main support post at the connection point; and
wherein, the vertical main support post is reinforced in a reinforcing direction by the bracing strut;
wherein, the installing of the fall protection cable system on the roof of the building including installing each of the plurality of support members, where the installing of each of the plurality of support members including:
attaching the vertical main support post to the top at the main support location of the roof via a main base; and
reinforcing the vertical main support post via the bracing strut by attaching the bracing strut to the top at the bracing support location via a bracing base, and interconnecting the bracing strut between the bracing base and the bracing connection on the vertical main support post.
